(19) United States
(12) Patent Application Publication
(10) Pub. No.: US 2004/0107996 A1
(43) Pub. Date: Jun. 10, 2004

(54) Variable flow control apparatus

(76) Inventors: Robert W. Crocker, Fremont, CA (US); Kamlesh D. Patel, Livermore, CA (US); Gabriela S. Chirica, Livermore, CA (US)

Correspondence Address: Timothy P. Evans, Sandia National Laboratories, MS 9031, 7011 East Avenue, Livermore, CA, 94550, US

(21) Appl. No.: 10/314,707

(22) Filed: Dec. 9, 2002

(51) Int. Cl. G05D 7/06

(52) U.S. Cl. 137/487.5

(57) ABSTRACT

A flow control apparatus for controlling and regulating liquid flow rates. The apparatus is designed for the regulation and control of the flow of very small quantities of liquid over a continuous range from a few microliters/min to below one nanoliter/min from a high pressure source. The apparatus comprises a low permeability liquid flow channel, electrodes positioned within the liquid flow channel; and a power supply connected to the electrodes. Connected to the outlet of a high pressure liquid source, such as an electrokinetic pump, the variable flow apparatus controls flow from the pump by generating an opposing or augmenting electroosmotic within the low permeability flow channel. By adding an accumulator in combination with the variable flow apparatus to modulate the pressure-driven flow from the accumulator, the dynamic flow range is enhanced.

### STATEMENT OF GOVERNMENT INTEREST

This invention w as made with Government support under contract no. DE-AC04-94AL85000 awarded by the U. S. Department of Energy to Sandia Corporation. The Government has certain rights in the invention.

### CROSS-REFERENCE TO RELATED APPLICATIONS

Not applicable.

### FIELD OF THE INVENTION

The present invention relates generally to apparatus for controlling and regulating mass flowrates of submicroliter quantities of liquid in high pressure regimes and particularly for controlling and regulating mass flowrates in high pressure microfluidic devices.

### BACKGROUND OF THE INVENTION

Microfluidic devices are becoming increasingly important as means for chemical and biological analysis, chemical synthesis, and experimentation. Their attraction lies in the fact that miniaturization provides for substantial advantages in terms of cost, speed, the capability for easy automation, reproducibility, and the need for only very small (μL) samples. Because of the need for only very small samples and the capability for rapid analysis microfluidic devices have found particular application in chromatographic analysis. However, the ability to carry out analyses of small volumes of sample, while desirable in itself, poses a significant problem namely, the need for accurate control of flow rates of very small (microliter) liquid volumes. For accurate chromatographic analysis, control of flowrate in the range of μL/min to μL/min is required. In this flow regime there are no convenient means to control liquid flow. Conventional mechanical valves having adjustable orifice areas, such as needle or metering valves are able to regulate liquid flow rates of milliliters/min but are unreliable below a few microliters/min. Other means of flow control include positive displacement pumps such as syringe pumps fitted with microliter syringes. However, syringe pumps are only useful are pressures below about 1000 psi. For higher pressures (up to ≈5000 psi) HPLC pumps can be employed, however, they are only capable of controlling liquid flow at flow rates greater than microliters/min. Another approach to controlling liquid flow rates in the μL/min or less range can be the use of a valved manifold having a plurality of assorted fixed flow restrictions. This approach, however, is of very limited value due to size, complexity, and discrete number of restriction combinations.

### SUMMARY OF THE INVENTION

Accordingly, the present invention is directed, in part, to a variable flow control apparatus capable of controlling and regulating flowrates of very small quantities of liquid over a continuous range from a few microliters/min to below one nanoliter/min. The apparatus is particularly useful for accurate flow regulation and valving functions in high pressure microfluidic applications where no other comparable technology exists, such as microanalytical chromatography separations, microfluidic hydraulic actuators, and microfluidic fuel pumps for combustion-based propulsion systems.

In one embodiment the flow control apparatus comprises at least one capillary or microchannel having a low permeability flow restriction. Flow control is obtained by electroosmotic flow restriction. This restriction can be achieved by packing immobile particles or monolithic porous polymer materials, such as described in U.S. patent application Ser. Nos. 09/796,762, filed Feb. 28, 2001, or ceramic media in the interior. Instead of a packed column the capillary or microchannel can be provided with integrally defined features to restrict permeability. The capillary or microchannel can also be made of an electrokinetically active material. Electrodes are positioned at the inlet and outlet end to provide an electric field along the liquid flow direction. Liquid flow, and particularly liquid flow from a high pressure source, is regulated by controlling the electric field within the flow restrictor apparatus

### BRIEF DESCRIPTION OF THE DRAWINGS

FIG. 1 is a schematic drawing of an embodiment of the invention.

FIG. 2 shows measurements of liquid flow rate for two voltages applied to a variable flow restriction apparatus.

FIG. 3 shows attenuation of liquid flow rate by a variable flow restriction apparatus.

FIG. 4 is a schematic drawing of a system for enhanced dynamic flow.

### DETAILED DESCRIPTION OF THE INVENTION

The present invention pertains to a variable flow control apparatus for regulating and controlling flow rates of liquids, and particularly of very small (microliter) quantities of liquid, in the range of μL/min to μL/min. The apparatus is particularly useful for accurate flow control and valving functions in high pressure microfluidic devices where no other comparable technology exists.

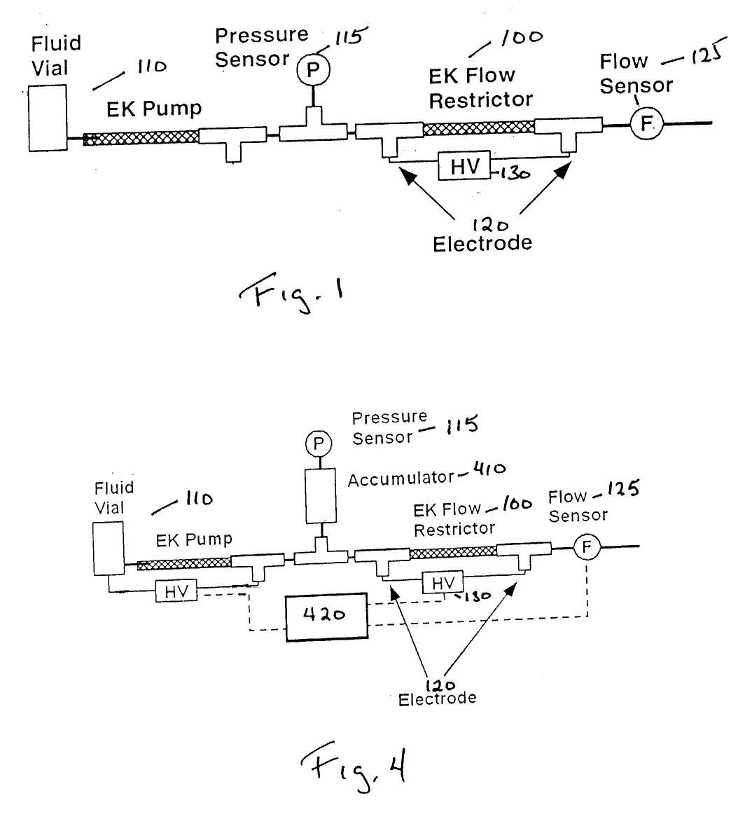

The operation of the invention w ill be illustrated by reference to FIG. 1. The variable flow control apparatus 100 is disposed between a high pressure source of liquid 110 and a desired delivery point. High pressure liquid source 110 can be a pressurized reservoir, an HPLC pump or other mechanical pump or, as illustrated in FIG. 1, an electrokinetic pump such as described in U.S. Pat. No. 6,277,257 “Electrokinetic High Pressure Hydraulic System”. Here, high pressure is intended to mean pressures in excess of about 100 psi. The outlet of high pressure liquid source 110 is joined to the inlet of variable flow controller 100. Flow controller 100 is designed to have a permeability for liquid flow that falls in the range of from about 1×10⁻⁶ to about 1×10⁻¹⁴/cm². This can correspond to flow through a porous medium having pore sizes in the range of about 50-5000 nm and void fractions from 0.22 to 0.9. Here, permeability is expressed in dimensions of cm⁻² so that it is independent of variable parameters such as length, cross-sectional area, and liquid viscosity.

The apparatus comprises at least one capillary or microchannel having a low permeability for liquid flow. Alternatively, the apparatus can comprise a plurality of capillaries or microchannels that together provide a low permeability for liquid flow. Low permeability, as defined above, can also be achieved by packing a bed of immobile particles in the microchannel. Instead of a packed column the capillary or microchannel can be provided with integrally defined features to restrict permeability such as constrictions, narrow parallel channel arrays, or channels with arrays of defined flow obstacles such as round or polygonal posts. The capillary or microchannel can be made of an electrokinetically active material, i.e., a material having a non-zero surface zeta potential in the liquid of interest. An electrode 120 is provided at both the inlet and outlet end to produce an electric field along the flow direction. A high voltage power supply 130 is connected to electrodes 120.

The flow through the apparatus has two governing components: a pressure-driven permeation flow and an electric field-driven electroosmotic flow. Pressure-driven permeation flow from high pressure source 110 is controlled by the electric field-driven electroosmotic flow within flow controller 100. The liquid flow rate delivered to the delivery point ranges from a minimum, in which case the maximum electric field drives an opposing electroosmotic flow against the pressure-driven permeation flow to restrict flow therethrough, to a maximum flow, wherein the electric field within the apparatus is reversed to augment the permeation flow. Adjusting the applied voltage controlling the electric field within the flow restriction apparatus spans these extremes. The mid-point of the flow range occurs at zero applied voltage to electrodes 120.

The ability of the apparatus to accurately control and regulate liquid flow rates in the nL/min range is show n in the example below .

### EXAMPLE 1

In this example, an electrokinetic pump (EKP) was used as the source of high pressure liquid 110. A pressure sensor 115 was positioned between the outlet of the EKP and the inlet of variable flow restrictor (VFR) 100. A flow sensor 125 was disposed at the outlet end of the VFR. The working liquid was 10 mM tris(hydroxymethyl)aminomethane adjusted to pH 8.5 in deionized water. Initially, zero volts were applied to the VFR and the pressure was measured as the liquid flow rate through the apparatus was adjusted by varying the voltage applied to the EKP. Subsequently, a voltage of 500 V was applied to the VFR and the liquid flow rate adjusted as before. The results are show n in FIG. 2 as a plot of flow rate vs. inlet pressure. The pressure/flow rate curves are linear and parallel, having identical slope, but offset by an amount proportional to the voltage applied to the VFR. These results indicate that incorporation of the VFR in the liquid flow path, by itself, has the same effect on flow rate as an ordinary fixed flow restriction. Application of an electric field to the VFR can be used to retard liquid flow from the EKP w hen the electric field is oriented so as to drive an opposing electrokinetic flow against the pressure-driven flow from the EKP. By way of example, the flow rate from the EKP is reduced from 40 nL/min to about 27 nL/min by application of 500 V to the VFR. Conversely, by orienting the electric field in the opposite direction the VFR can be used to augment the flow from the liquid source and completely eliminate any restrictive effects of the device. Fluid flow can be regulated automatically by feedback control means connected between an output flow sensor, the high pressure liquid source and the high voltage power supply of the VFR.

### EXAMPLE 2

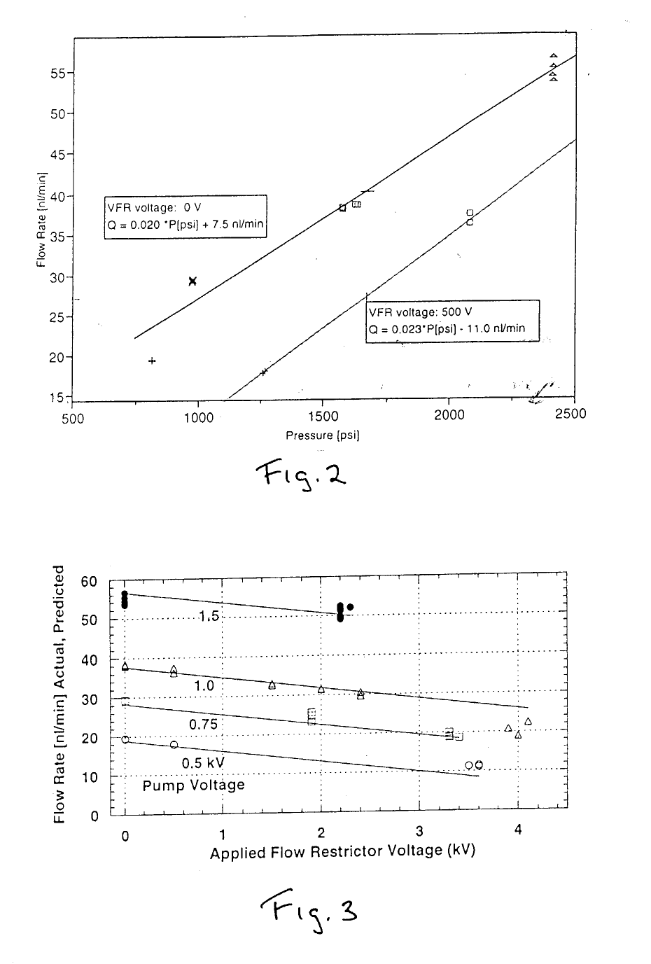

The experimental arrangement of example 1 was used to demonstrate the ability of the VFR to regulate a range of flow rates. An EKP was held at a series of constant applied voltages, i.e., a series of liquid flow rates, and the flow rate measured as the voltage applied to the VFR w as varied. The results of these studies are shown in FIG. 3. It can be seen that as the voltage applied to the VFR w as increased for a given flow rate the flow rate was attenuated in a continuous and linear manner.

Another aspect of the invention, is show n in FIG. 4, and consists generally of a high pressure liquid source 110, such as an EKP and VFR 100. As will be appreciated by those skilled in the art, it can be desirable to add a pressurized liquid accumulator volume 410 at the connection between liquid source 110 and VFR 100. Pressure measuring means 415, such as a pressure sensor can be connected to accumulator 410. Here, as in example 1, output flow can be regulated by feedback control means, such as flow controller 420, connected between output flow sensor 125, high pressure liquid source 110, and high voltage power supply 130 to control the voltage supplied to the electrodes 120 of VFR 100.

EKP 110 can deliver liquid directly to VFR 100 or, preferably to an accumulator 410 at high pressure. The liquid can be stored in accumulator 410 at high pressure maintained by volumetric compression. Compression can be by compression of an immiscible liquid, such as air or other gases or organic liquids (with aqueous pumping liquid), with or without a bladder or other membrane, by the elastic response of the material of the accumulator, membrane, or by a mechanically driven piston. In order to pressurize the accumulator, flow output from the EKP is restricted or stopped by flow restrictor 100. Once the accumulator is at the desired pressure, the mass flow controller is ready for liquid delivery. Liquid delivery can be accomplished by controlling the electric potential of electrodes 120. Liquid flow is created by a combination of a pressure-driven component of the flow from accumulator 410 with an electrokinetic component of the flow that may augment or oppose the pressure-driven component. During liquid delivery, EKP 110 can be driven to replenish the accumulator. By adding an accumulator in combination with the novel variable flow restrictor to modulate the pressure-driven flow from the accumulator, the dynamic flow range can be enhanced.

We claim:

1. An apparatus for controlling and regulating liquid flow, comprising:
a) a liquid flow channel having a low permeability for liquid flow, w herein said flow channel has an inlet and an outlet, w herein the inlet is joined to a high pressure liquid source and the outlet joined to a delivery point;
b) spaced electrodes disposed within said liquid flow channel; and
c) a power supply connected to said spaced electrodes.

2. The apparatus of claim 1, wherein said flow channel comprises a plurality of capillaries or microchannels.

3. The apparatus of claim 1, wherein low permeability is provided by incorporating immobile particles within said flow channel.

4. The apparatus of claim 1, wherein low permeability is provided by incorporating a porous polymer material or ceramic medium within said flow channel.

5. The apparatus of any of claims 1, 2, 3, or 4 wherein the permeability of the liquid flow channel is between about 1×10⁻⁶ to about 1×10⁻¹⁴/cm².

6. The apparatus of claim 1, w herein the high pressure liquid source is an electrokinetic pump.

7. The apparatus of claim 1, further including feedback control means.

8. A mass flow controller, comprising:
a) a high pressure liquid source having an inlet and an outlet; and
b) a variable flow controller, wherein said flow controller comprises;
a liquid flow channel having a low permeability for liquid flow, wherein said flow channel has an inlet and an outlet, wherein the inlet is joined to a high pressure liquid source and the outlet joined to a delivery point,
spaced electrodes disposed within said liquid flow channel, and
a power supply connected to said spaced electrodes.

9. The mass flow controller of claim 8, further including a liquid accumulator connected to the junction between the high pressure liquid source and the variable flow controller.

10. The mass flow controller of claim 8, further including feedback control means for controlling liquid flow from said variable flow controller.

11. The mass flow controller of claim 8, wherein said flow channel comprises a plurality of capillaries or microchannels.

12. The mass flow controller of claim 8, wherein low permeability is provided by incorporating immobile particles within said flow channel.

13. The mass flow controller of claim 8, wherein low permeability is provided by incorporating a porous polymer material or ceramic medium within said flow channel.

14. The mass flow controller of any of claims 8, 11, 12, or 13 wherein the permeability of the liquid flow channel is between about 1×10⁻⁶ to about 1×10⁻¹⁴/cm².

15. The mass flow controller of claim 8, wherein said high pressure liquid source is an electrokinetic pump.

16. A liquid flow controller for a high pressure microfluidic device, comprising:
a substrate fabricated to define a microchannel system disposed thereon, the microchannel system, in part, comprising:
a) a liquid flow channel having a low permeability for liquid flow, wherein said flow channel has an inlet and an outlet, wherein the inlet is joined to a high pressure liquid source and the outlet joined to a delivery point;
b) spaced electrodes disposed within said liquid flow channel; and
c) a power supply connected to said spaced electrodes.

17. The apparatus of claim 16, wherein said flow channel comprises a plurality of capillaries or microchannels.

18. The apparatus of claim 16, wherein low permeability is provided by incorporating immobile particles within said flow channel.

19. The apparatus of claim 16, wherein low permeability is provided by incorporating a porous polymer material or ceramic medium within said flow channel.

20. The apparatus of any of claims 16, 17, 18, or 19 wherein the permeability of the liquid flow channel is between about 1×10⁻⁶ to about 1×10⁻¹⁴/cm².

21. The apparatus of claim 16, wherein the high pressure liquid source is an electrokinetic pump.

22. A method for controlling and regulating liquid flow, comprising:
a) providing a high pressure liquid source having an inlet and an outlet;
b) connecting the apparatus of claim 1 to the outlet of the liquid source;
c) controlling the rate of liquid flow from the source by applying a voltage to said spaced electrodes.

23. The method of claim 22, further including providing a pressure accumulator positioned at the junction between the high pressure liquid source and the apparatus of claim 1.
